(19) United States
(12) Patent Application Publication
(10) Pub. No.: US 2026/0148285 A1
(43) Pub. Date: May 28, 2026

(54) CLUSTERING OF ITEMS FOR MULTI-SOURCE SERVICING OF AN AGGREGATED LIST OF ITEMS

(71) Applicant: Maplebear Inc., San Francisco, CA (US)

(72) Inventors: Naval Shah, Toronto (CA); Riddhima Sejpal, Dublin, CA (US)

(21) Appl. No.: 18/963,232

(22) Filed: Nov. 27, 2024

(51) Int. Cl. G06Q 30/0601; G06F 16/954

(52) U.S. Cl. CPC G06Q 30/0641; G06F 16/954; G06Q 30/0633

(57) ABSTRACT

An online system performs clustering of items for multi-source servicing of an aggregated list of items for a user of the online system. Upon receiving the aggregated list and identifying that the aggregated list is unserviceable by a single source, the online system applies either a trained machine-learning model or the nearest neighbor algorithm to embeddings of items from the aggregated list to cluster items from the aggregated list into multiple clusters, each cluster of items serviced by a single source that is unique for that cluster. The online system generates, using order data for the user and the clusters of items, multiple orders and assigns the orders to sources, where each order includes items from a respective cluster. The online system uses the orders to generate a user interface signal causing a user’s device to display a user interface with information about the orders and the sources.

### BACKGROUND

Online systems allow their users to browse and acquire items by placing online orders. Additionally, the online systems allow their users to build a list of items for acquisition outside of their platforms, such as from third-party applications or offsite recipe sites. Online users have a variety of mechanisms to construct a list of items to be brought to an online system for acquisition. These mechanisms may include third-party applications that are integrated with the online system platform (e.g., mobile applications and tools to build an acquisition list), integrations via smart home assistants or devices (e.g., smart fridges, voice assistants, etc.), or a source-agnostic acquisition list functionality of an online system platform. When a list of items for acquisition is brought to an online system, the online system needs to find a source (e.g., retailer) from which an order related to the list of items can be serviced (i.e., fulfilled).

However, as the lists of items for acquisition get more complicated, the entire list of items cannot be fulfilled from a single source. As online systems have spread to verticals other than strictly grocery, it becomes increasingly complex when users are putting together lists of items for acquisition where the items on the list vary across verticals. The traditional method of identifying a ‘best match’ source based on a variety of factors cannot be applied for more complex and varying lists of items for acquisition. In such cases, users are put in a situation where they cannot fulfill an order for the items on their list, which causes users’ frustration and lost transactions.

Hence, there is a need to find a way to split a complex aggregated list of items for acquisition into multiple lists, where each sub-list can be fulfilled from a single source. However, the splitting should be unbiased. Additionally, it is desirable not to favor one source over another or create price competition between sources.

### SUMMARY

Embodiments of the present disclosure are directed to clustering of items for multi-source servicing of an aggregated list of items.

In accordance with one or more aspects of the disclosure, the online system receives, from an online platform and via an interface of an online system, a request signal including an aggregated list of items and an identity of a user of the online system associated with the aggregated list. Responsive to the received request signal, the online system generates an order including the aggregated list of items. The online system identifies, based at least in part on a catalog of items of a single source, that the order is unserviceable by the single source. Responsive to identifying that the order is unserviceable, the online system generates, for each of the items in the aggregated list, an embedding vector of a plurality of embedding vectors, wherein the embedding vector is generated by: retrieving, from a database of the online system, information about past orders placed at the online system, deriving, using the retrieved information, cooccurrence data for each of the items in the aggregated list including information about cooccurrences in the past orders of each of the items in the aggregated list with other items in the aggregated list, and including, using the cooccurrence data, an indication about a cooccurrence of each of the items in the aggregated list with a corresponding other item in the aggregated list into a corresponding dimension of the embedding vector thereby reducing a first dimensionality of the cooccurrence data to a second dimensionality of the embedding vector. The online system clusters, using the plurality of embedding vectors for the items in the aggregated list, the aggregated list of items to a plurality of clusters of items, each of the plurality of clusters serviced by a different source. The online system generates, using order data for the user, a plurality of orders by including one or more items from each of the plurality of clusters to a respective order of the plurality of orders and assigning a different source of a plurality of sources to the respective order. The online system generates, using the plurality of orders, a user interface signal. The online system sends, via a network, the user interface signal to a device associated with the user, wherein the sending causes the device associated with the user to display a user interface with information about the plurality of orders and the plurality of sources for servicing the plurality of orders.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example architectural flow diagram of using a trained machine-learning model of an online system for multi-source servicing of an aggregated list of items, in accordance with one or more embodiments.

FIG. 4 is a flowchart for a method of clustering of items for multi-source servicing of an aggregated list of items, in accordance with one or more embodiments.

### DETAILED DESCRIPTION

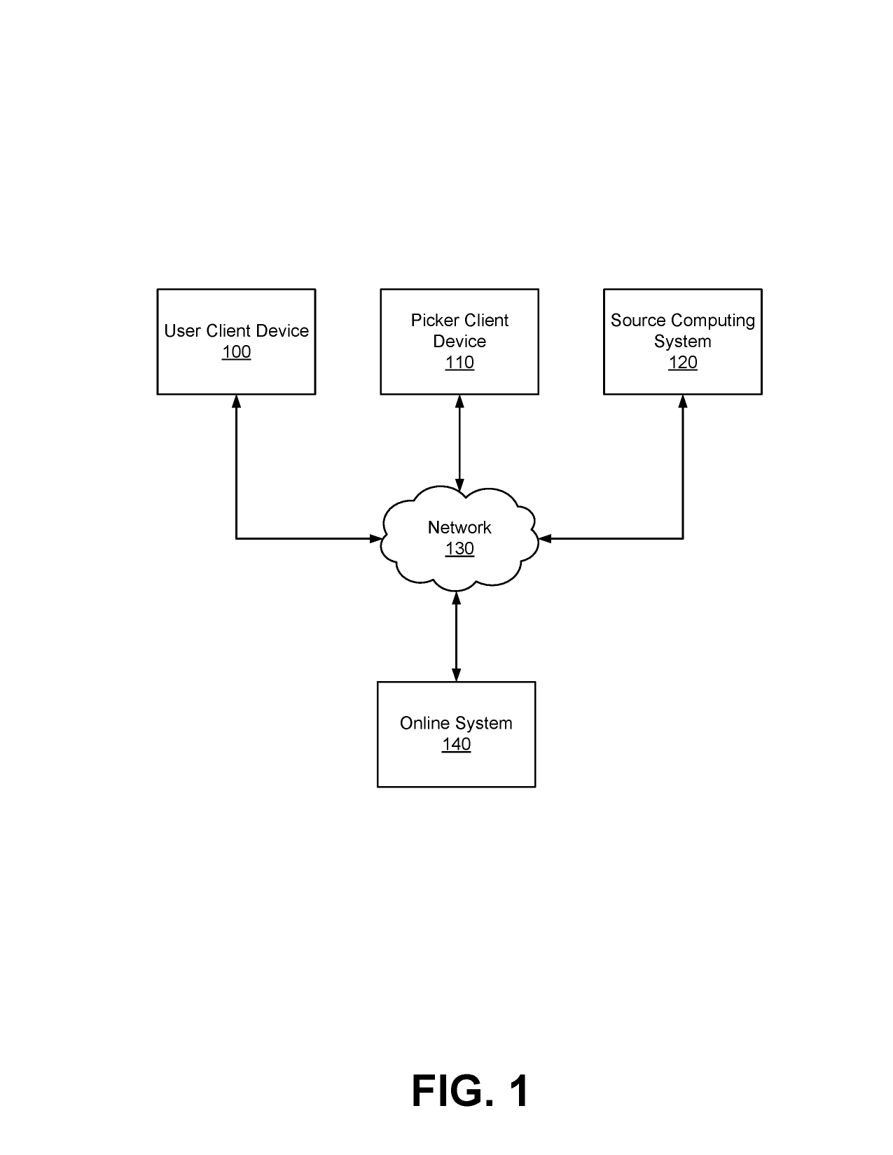

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker (i.e., fulfillment agent, servicing agent, or agent) that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a source location. The user’s order may specify which groceries they want to be delivered from the source location and the quantities of each of the groceries. The user client device 100 transmits the user’s order to the online system 140 and the online system 140 selects a picker to travel to the source location to collect the groceries ordered by the user. The online system transmits an offer to the picker for the picker to service the order in exchange for consideration and, if the picker accepts the offer, the picker collects the groceries from the source location. Once the picker has collected the groceries ordered by the user, the picker delivers the groceries to a location transmitted to the picker client device 110 by the online system 140.

The online system 140 may fulfill orders generated from lists created by third-party applications. Because the third-party applications do not know the sources for fulfilling the items in the lists, the online system 140 may need to select multiple sources for a given list of items. To break a new list of items into subsets, each subset to be fulfilled from a different source, the online system 140 may cluster the items in the list according to a similarity score generated using a trained machine-learning model. The trained machine-learning model may generate the similarity score by comparing embeddings associated with the items in the list (e.g., information about past cooccurrences of each item in the list with other items within same orders). The machine-learning model may be trained based on how similar users’ have historically divided different items across multiple sources, so that the clustering is unbiased and generally follows how users are likely to split a list of items across multiple sources.

Hence, the online system 140 presented herein runs a machine-learning algorithm of the machine-learning model to cluster items in a list (e.g., shopping list or recipe list) by a source associated with the online system 140 from which the items in the list are sourced. The machine-learning model may be trained to cluster the items in the list in a way that a user of the online system 140 would likely do so. Alternatively, the machine-learning model may be trained to cluster items in the list by a conversion channel (e.g., method used to fulfill each item in the list), such as delivery, pickup, or purchase in a source location.

The machine-learning model presented herein may be trained to cluster items on a shopping list or recipe list such that each item in the list can be treated independently in terms of source/conversion channel matching and the creation of an order. The machine-learning model may be manually trained to achieve the source/conversion channel matching, i.e., from users who place multiple orders in short succession to different sources (e.g., one order for grocery, one for alcohol, one for party supplies, etc.) or to different conversion channels.

Users of the online system 140 are allowed to bring their shopping lists or recipes to the online system 140 for conversion. When the list spans more than one source or one conversion channel, the online system 140 runs the machine-learning model to match items in the list to multiple sources or multiple conversion channels, thus allowing fulfillment of the entire list of items. The machine-learning model may take as inputs items in the shopping list (or recipe) and split the items into clusters or categories that can each be used to match to a single source (or a single conversion channel). The approach presented herein can be used in the cases where a single source selected for a shopping list or recipe would result in a poor user’s experience and a missed transaction.

The approach presented herein can improve the experience for third party developers and applications, as their use cases can become more robust and can leverage the full spectrum of sources on the marketplace. The presented approach can also improve the users’ experience, since the online system 140 can provide intelligent source matching for a wide spectrum of shopping lists and recipes, while saving users’ time by allowing the users to fulfill more of their orders on the online system 140. Sources associated with the online system 140 can also benefit from this approach because when shopping lists are not fulfillable by a single source, there is an opportunity to facilitate multiple transactions from multiple sources. Additionally, there are more opportunities for pickers associated with the online system 140 to fulfill batches for users due to the increased transactions.

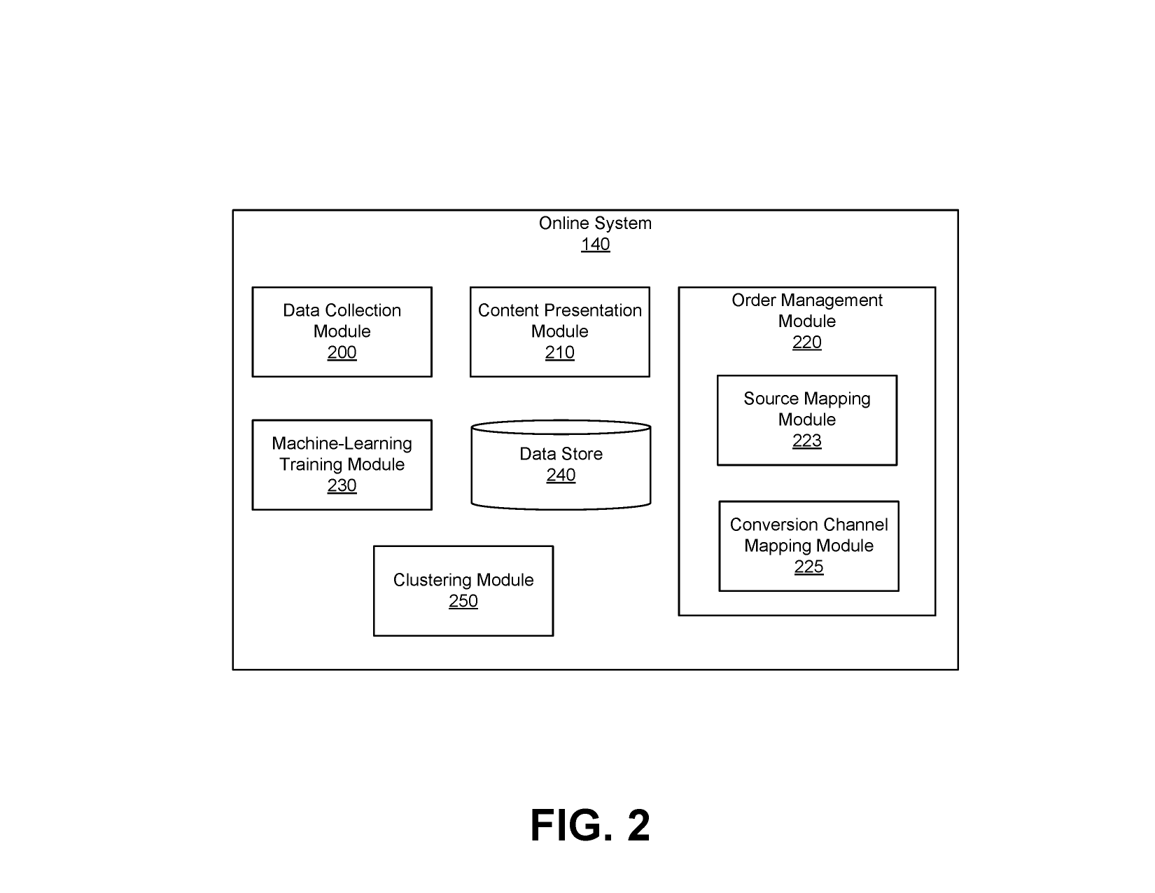

It should be noted that many recipes that include alcoholic drinks or vast variety of lists are traditionally not able to be fulfilled. For example, these are cocktails or mocktail recipes that include alcoholic items and some other non-alcoholic items (e.g., lime/salt or some other fruits). In such cases, the grocery sources can fulfill most of the items but may not carry alcoholic items in many regions which are critical for the recipes. The online system 140 that integrates the trained machine-learning model presented herein unblocks a use case of large number of recipes with a variety of items that are prevalent with some third parties associated with the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, and a clustering module 250. The order management module 220 may include a source mapping module 223 and a conversion channel mapping module 225. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The process flow for multi-source servicing of an aggregated list of items may start when the online system 140 receives the list of items for acquisition, e.g., from a third-party application or some other online platform that is separate from the online system 140. The clustering module 250 may receive the list of items and output multiple clusters of items, where each cluster of items may be serviced (or fulfilled) by a single source or using a single conversion (or fulfillment) channel. To achieve this, the clustering module 250 may utilize a trained clustering model (e.g., machine-learning model) that inputs embeddings of items in the list and cluster the items into distinct groupings (or clusters) that each will be used to generate an order from a single source (or a single conversion channel). For example, if the user’s list of items for acquisition at the online system 140 contains grocery items, party supplies, alcohol, and prepared foods, the trained clustering model may cluster the list of items accordingly and generate four groupings of items that each will then be matched and fulfilled by a single source.

An embedding of an item in the list includes an indication about past cooccurrences of that item with other items in the list within same past orders, where each past order was serviced by a single source. In one or more embodiment, the clustering module 250 (or some other module of the online system 140) generates an embedding vector each item in the list. In such cases, the clustering module 250 may retrieve, from an item catalog database and/or order catalog database (e.g., stored at the data store 240), information about past orders placed at the online system 140. The clustering module 250 may then include, using the retrieved information, an indication about a cooccurrence of each item in the list with a corresponding other item in the list into a corresponding dimension of the embedding vector. For example, the value of 0 may be included into a corresponding dimension of the embedding vector if each item in the list did not cooccur with a corresponding other item in the list within a same past order. Otherwise, the value of 1 may be included into a corresponding dimension of the embedding vector if each item in the list did cooccur with a corresponding other item in the list within a same past order.

The embeddings may be generated using the cooccurrences of the items in the user’s previous orders (or all users’ historical orders, or all users of the same cohort). As such, the embeddings for the items are vectors in a high-dimensional latent space, where the individual dimension in the latent space have no meaning, but the relative position of the embeddings have meaning – specifically, the distance between two vectors indicates how likely the items are to be in the same order or otherwise obtained from the same source/source location.

Note that one important purpose of utilizing embeddings is a dimensional reduction. If there are a very large number of items, N, then the cooccurrences of the items in past orders can be stored in an N x N matrix, which tends to be a relatively sparse matrix. Accordingly, as the data scales with the factor of N², it makes working with non-embedding information impossible on conventional real-world computing systems. However, by converting the item cooccurrence information into a single high-dimensional embedding vector for each item, the information scale linearly with N (e.g., if the number of items is doubled, the number of embeddings is only twice larger). This dimensional reduction is a solution to a technical problem of performing operations with very large datasets, such as the cooccurrence of items from a very large catalog in a set of historical orders (e.g., stored in the data store 240).

In one or more embodiments, the clustering module 250 accesses the clustering model that is trained to identify, for each item in a list of items, to which cluster of items of a plurality of clusters that item belongs to. The clustering module 250 may deploy the clustering model to run a machine-learning algorithm that compares an embedding of each item in the list (e.g., information about past cooccurrences of each item in the list with other items within same orders) with embeddings of items in each cluster of the plurality of clusters to generate a similarity score for each item and for each cluster of the plurality of clusters. The clustering model may then place each item in the list to a corresponding cluster of items for which a corresponding similarity score is the highest. The similarity score may be a value between 0 and 1, where a higher value of the similarity score may indicate a higher level of similarity of that item with items in a corresponding cluster of items. A set of parameters for the clustering model may be stored at one or more non-transitory computer-readable media of the clustering module 250. Alternatively, the set of parameters for the clustering model may be stored at one or more non-transitory computer-readable media of the data store 240.

The clustering model may initially try to place all items from the list according to their embeddings into some initial set of clusters (e.g., two clusters), where each cluster of items would be serviced by a single source. However, once the clustering model identifies that at least one cluster of items from the initial set of clusters cannot be serviced by one source, the clustering module 250 may allocate one or more additional clusters until the clustering model clusters all items from the list into a set of separate clusters, where each cluster can be serviced by a single separate source (or conversion channel).

The clustering model may return the list of items clustered into groupings (or clusters) that will be used for input into the order management module 220 (e.g., the source mapping module 223 or the conversion channel mapping module 225) for generating multiple orders to be serviced by multiple sources. In one or more embodiments, each cluster of items generated by the clustering module may be serviced as a separate order that can be fulfilled by a single source. In one or more other embodiments, each cluster of items generated by the clustering module may be serviced as a separate order that can be fulfilled using a specific conversion channel (or fulfillment type). For example, a cluster of produce items can be serviced as an in-store mode list, whereas a cluster of prepared food items can be serviced as a pickup order.

The clustering module may be trained to cluster the list of items in a neutral way, not favoring one source over another. In one or more embodiments, the clustering of items by the clustering module is not personalized, i.e., the clustering may be aggregated over a trained group of users. In one or more other embodiments, the clustering of items by the clustering module is personalized. For example, the clustering of items may be performed differently for a different region as the clustering model may be trained using user data from a particular region. In some cases, the clustering model may need to perform clustering of items on a per-region basis because it is possible that the patterns for sourcing items vary by region, especially where there are locales where grocery and alcohol cannot (or can) be acquired from a single source. Alternatively, the clustering model may perform clustering of items by a user cohort as the clustering model is trained using user data from a cohort of users of the online system 140. Alternatively, the clustering model may perform clustering of items at an individual level, i.e., personalized for a specific user of the online system 140. In such cases, inputs to the clustering model may include features of the specific user.

Thus, the clustering model may generate outputs that are aggregated over multiple users, or personalized for a specific user, cohort of users or regional users. In general, the clustering model may cluster a list of items into <source, conversion channel> groupings or clusters. For example, some items from the list will be delivered from Source A, some items from the list will be converted using an in-store mode of an application of the online system 140 at Source B, and some items from the list will be picked-up at Source C. To generate the <source, conversion channel> groupings personalized for a given user of the online system 140, the user’s order history and contextual information may be used as additional to the clustering model.

The machine-learning training module 230 may perform initial training of the clustering model using training data. The machine-learning training module 230 may generate the training data based on historical orders from a collection of users of the online system 140, where a user from the collection of users creates multiple orders from different sources within a time period (e.g., two hours). The machine-learning training module 230 may then create a training example of the superset of the ordered items, with the clusters defined according to the different orders that the user created. Additionally, the machine-learning training module 230 may create embeddings based on the cooccurrences of items in the user’s orders and based on the ground truth that the user put different items into different orders. Additional training data may be generated from the users when the sub-lists are presented as the user would be able to confirm mapping of sub-lists to specific sources and/or conversion channels or select some other sources and/or conversion channels. The machine-learning training module 230 may train the clustering model using the training data to generate initial values for the set of parameters of the clustering model.

In general, the clustering model may be trained on the filtered order history that reflects a multi-source fulfillment, i.e., using information about orders that emulate multi-source fulfillment. The goal is to train the clustering model to be unbiased, i.e., the clustering model may need to be trained to recommend a split of the list of items that reflects what users of the online system 140 would do. Among a collection of orders having their details stored in an order catalog database (e.g., at the data store 240), the machine-learning training module 230 may identify a set of orders made within a designated time window (e.g., two hours) placed by a same user of the online system 140 as orders that emulate the multi-source fulfillment of an aggregated list of items. For example, a user of the online system 140 makes three orders from three different sources during the designated time window. The machine-learning training module 230 may feed those items and associated search terms or shopping list line items into the clustering model to indicate they have affinity for each other. The machine-learning training module 230 may have, for each of these orders, all of the search terms and shopping list terms, a found rate for each item, a label indicating a fulfilled order or a label indicating a failed order, user rating, region information (e.g., ZIP code information for regional personalization), etc.

Alternatively, the clustering module 250 may apply the nearest neighbor algorithm to embeddings of items in the list (e.g., information about past cooccurrences of each item in the list with other items within same orders) to cluster the list of items into separate cluster of items, where each cluster includes a subset of the items from the list that have their embedding vectors within a threshold distance from each other. In this manner, each subset of items from the list that are grouped into a corresponding cluster can be serviced by a single source or a single conversion channel (e.g., single delivery type).

Once the embedding vector for each item in the list is obtained, the clustering module 250 may apply the nearest neighbor algorithm to group the items from the list into multiple clusters, where each cluster of items is serviced by a single source. At the first step, the clustering module 250 may compute distances between embedding vectors for each pair of items. At the second step, the clustering module 250 may cluster (or combine) the items that have the closest distance between their embedding vectors. At the third step, the clustering module 250 may recompute an embedding for each new cluster using, e.g., a centroid of its member items’ embeddings. At the fourth step, the clustering module 250 may recompute a distance of each new cluster to the other items and/or clusters. After that, the clustering module 250 may repeat the second, third and fourth steps until a stopping condition is met when all items from the list are grouped into clusters, where all items from each cluster may be serviced by a single source that is unique for that cluster. The stopping condition may be, e.g., to continue clustering until the items in a cluster cannot be serviced from a single source location, so then that cluster is set and all items from that cluster are serviceable in a single order from a single source location.

The source mapping module 223 may assign a cluster of a plurality of clusters of items generated by the clustering model to a particular source (e.g., retailer) using order history data for a given user of the online system 140. The source mapping module 223 may retrieve the order history data for the given user from a user catalog database (e.g., at the data store). Hence, the mapping of clusters to sources may be personalized for the given user. The order management module 220 may then utilize information about the mapping of clusters to sources when generating orders that correspond to the clusters.

The conversion channel mapping module 225 may assign a cluster of the plurality of clusters of items generated by the clustering model to a particular conversion channel (e.g., fulfillment type) using order history data for a given user of the online system 140. Hence, the mapping of clusters to conversion channels may be personalized for the given user. The order management module 220 may then utilize information about the mapping of clusters to conversion channels when generating orders that correspond to the clusters.

The order management module 220 may generate orders based on the assigned clusters, i.e., based on assignment of clusters to specific sources and/or conversion channels. Additionally, the content presentation module 210 may generate a user interface signal (e.g., user interface information) with information about the assigned clusters. The content presentation module 210 may send, via the network 130, the user interface signal to the user client device 100, wherein the sending causes the user client device to display a user interface with clusters of items assigned to specific sources and/or conversion channels. The user may then utilize user interface elements to confirm the orders for fulfillment using the specified sources and/or conversion channels. Alternatively, the user may utilize the user interface elements to select some alternative assignment of sources and/or conversion channels for fulfillment of the orders.

The machine-learning training module 230 may collect feedback data with information about a reaction by a user of the online system 140 when clusters of items assigned to particular sources and/or conversion channels are presented via a user interface of the user client device 100. For example, the user may accept all source/conversion channel assignments, and this information may be used as a positive reinforcement for re-training of the clustering model. Alternatively, the user may change one or more source/conversion channel assignments, and this information may be used as a negative reinforcement for re-training of the clustering model. The information about the user’s reaction may be recorded at the user client device 100 and communicated, via the network 130, to the online system 140 and the machine-learning training module 230 as the feedback data. The machine-learning training module 230 may then re-train the clustering model by updating the set of parameters of the clustering model using the feedback data.

The prototypical use case will be presented herein. A user of the online system 140 may use a third-party application to build a list of items for acquisition at the online system 140 (e.g., shopping list of recite). For example, the list of items for acquisition contains the following items: milk, bread, coffee beans, frozen pizza, salad mix, apples, oranges, beer, vodka, red solo cups, paper napkins, disposable plates, plastic cutlery, party balloons, sandwich platter, and hot wings. The user may be redirected to the online system 140 via the third-party application. The order management module 220 that initially tries to match the list of items to a source associated with the online system 140 may output an indication that a top source match is below a matching threshold. For example, a single source can only fulfill half of the list of items.

After that, the online system 140 may invoke the clustering model to divide the list of items into distinct clusters. For example, the clustering model may split the list of items into two clusters and repeat the previous step of mapping items from the list to one of these two clusters. This process may continue until each cluster hits a minimum threshold for matching. At some point during the process of matching items to clusters, the clustering model may generate a signal for prompting the user via a user interface of the user client device 100 to confirm if the matching of items to clusters is acceptable to the user.

At the end of the process, all grocery items from the list of items may be matched to a grocery source, all alcoholic items from the list of items may be matched to an alcohol or liquor source, all party supplies from the list of items may be matched to a source specializing in bulk supplies for parties, and prepared food items from the list of items may be matched to a restaurant source. The user sees a streamlined experience that shows clearly which items matched to what source and/or conversion channel, and the user can adjust the source and/or conversion channel for each cluster of items. In this particular example, the user may place four separate orders. The online system 140 may choose to batch all four orders together for delivery or let them be fulfilled separately as they would normally be fulfilled if submitted manually, especially if at least one of the orders would have a different conversion channel (e.g., pick-up order of the prepared food items matched with the restaurant source). The online system 140 may have a full flexibility on how to batch, display and track these orders.

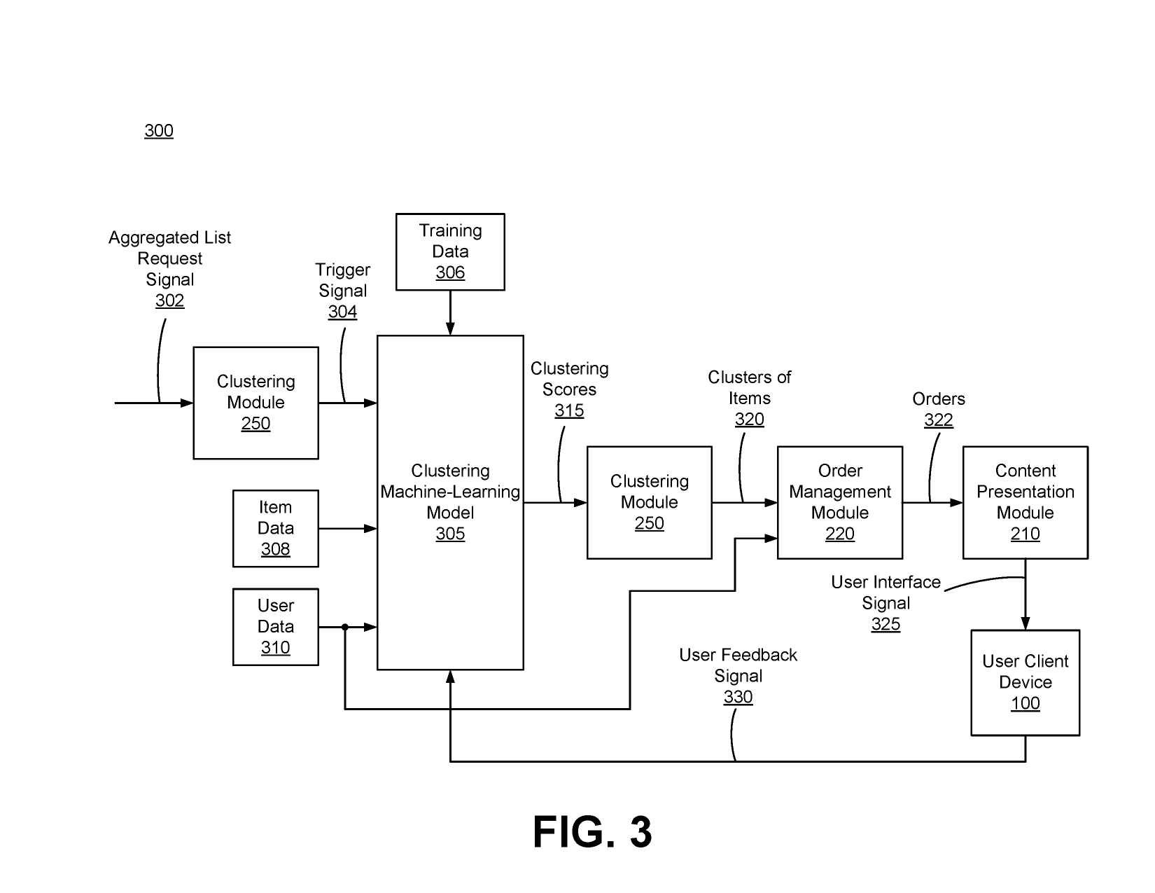

FIG. 3 illustrates an example architectural flow diagram 300 of using a clustering machine-learning model 305 of the online system 140 for multi-source servicing of an aggregated list of items, in accordance with one or more embodiments. The process flow may start upon receiving at the clustering module 250 (e.g., from a third-party application and via an API) an aggregated list request signal 302 including an aggregated list of items and an identity of a user of the online system 140 who requested servicing of the aggregated list of items. Responsive to the aggregated list request signal 302, the clustering module 250 may generate an order including the aggregated list of items. Upon identifying, based on embeddings of items in the aggregated list, that the order is unserviceable by a single source, the clustering module 250 may generate a trigger signal 304. The clustering module 250 may pass the trigger signal 304 to the clustering machine-learning model 305 to initiate running of a machine-learning algorithm of the clustering machine-learning model 305.

Prior to running the machine-learning algorithm of the clustering machine-learning model 305, the online system 140 may perform (e.g., via the machine-learning training module 230) initial training of the clustering machine-learning model 305 using training data 306 to generate initial values for a set of parameters of the clustering machine-learning model 305. The training data 306 may be generated (e.g., via the machine-learning training module 230) by retrieving, from a database of the online system 140 (e.g., the data store 240), order data related to multiple sets of orders, where each set of orders is placed by a corresponding user of the online system 140 within a threshold time period, and generating labels for the training data that include information about a source used for servicing each order from the set of orders and information about embeddings of items in each order from the set of orders. After the training process is completed, the online system 140 may provide a set of inputs to the clustering machine-learning model 305 (e.g., via the clustering module 250), such as item data 308 and user data 310. Some additional inputs not shown in FIG. 3 may be further provided to the clustering machine-learning model 305.

In providing the item data 308 to the clustering machine-learning model 305, the clustering module 250 may provide embeddings of items in the aggregated list of items. An embedding of each item may be a vector with an indication in each vector dimension about a cooccurrence of that item with a respective other item from the aggregated list of items within same past orders, where each order was serviced by a single source. The clustering module 250 may retrieve the item data 308 from an item catalog database (e.g., stored at the data store 240).

In providing the user data 310 to the clustering machine-learning model 305, the clustering module 250 may provide information about a collection of orders placed by the user that were serviced by a collection of sources, where information about each order include embeddings of items in each order from the collection of orders and a source that serviced that order. The clustering module 250 may retrieve the user data 310 from a user catalog database (e.g., stored at the data store 240) using the identity of the user obtained as part of the aggregated list request signal 302.

Upon receiving the trigger signal 304, the clustering machine-learning model 305 may apply the machine-learning algorithm to the item data 308 and, optionally, to the user data 310 to generate clustering scores 315 for each item from the aggregated list, each clustering score 315 indicating a likelihood that each item from the aggregated list belongs to a respective cluster of items. The clustering machine-learning model 305 may pass the clustering scores 315 for each item from the aggregate list to the clustering module 250. The clustering module 250 may then group each item from the aggregated list into a corresponding cluster of items 320 using the clustering scores 315, such that the corresponding cluster of items 320 is associated with the highest clustering score 315 of all the clustering scores 315 for that item. The clustering module 250 may pass information about the clusters of items 320 (i.e., grouping of all items from the aggregated list) to the order management module 220.

The order management module 220 may generate, using the user data 310, orders 322 assigned for servicing to multiple sources, where each order 322 includes items from a respective cluster of items 320, and each order 322 would be serviced (if accepted by the user) by a different source. The order management module 220 may pass information about the orders 322 to the content presentation module 210. The content presentation module 210 may use information about the orders 322 to generate a user interface signal 325 (e.g., user interface information) that includes the information about the orders 322. The content presentation module 210 may send the user interface signal 325, via the network 130, to the user client device 100. The user interface signal 325 may cause the user client device 100 to display a user interface with the information about the orders 322 and the sources that were assigned for servicing the orders 322.

The user client device 100 may generate and record a user feedback signal 330 with information about an engagement by the user with the orders 322. The engagement may be accepting servicing of the orders 322 using the assigned sources as displayed at the user interface or modifying servicing of the orders 322 by selecting some other source or conversion channel for servicing at least one of the orders 322. The online system 140 may receive (e.g., at the machine-learning training module 230) the user feedback signal 330 from the user client device 100 via the network 130. The machine-learning training module 230 may utilize the user feedback signal 330 to re-train the clustering machine-learning model 305. By utilizing user feedback signals 330 from various users over time, the machine-learning training module 230 may continuously update the set of parameters of the clustering machine-learning model 305 and continuously improve the machine-learning algorithm of the clustering machine-learning model 305.

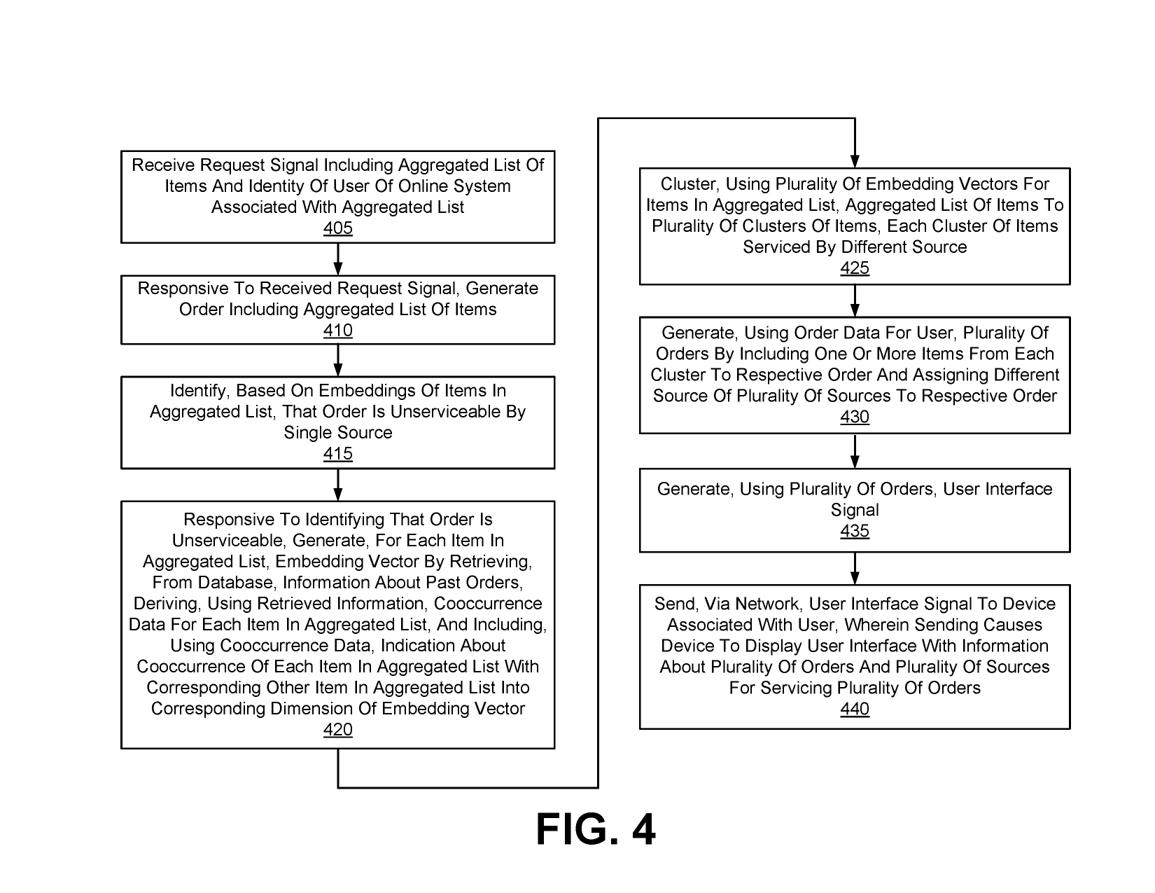

FIG. 4 is a flowchart for a method of clustering of items for multi-source servicing of an aggregated list of items, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., at the order management module 220), from an online platform (e.g., third-party application) and via an interface of the online system 140 (e.g., API), a request signal including an aggregated list of items and an identity of a user of the online system 140 associated with the aggregated list. Responsive to the received request signal, the online system 140 generates 410 (e.g., via the order management module 220) an order including the aggregated list of items. The online system 140 identifies 415 (e.g., via the order management module 220), based at least in part on a catalog of items of a single source (e.g., stored at the data store 240), that the order is unserviceable by the single source.

Responsive to identifying that the order is unserviceable, the online system 140 generates 420 (e.g., via the clustering module 250), for each of the items in the aggregated list, an embedding vector of a plurality of embedding vectors by retrieving, from a database of the online system 140 (e.g., the data store 240), information about past orders placed at the online system 140, deriving, using the retrieved information, cooccurrence data for each of the items in the aggregated list including information about cooccurrences in the past orders of each of the items in the aggregated list with other items in the aggregated list, and including, using the cooccurrence data, an indication about a cooccurrence of each of the items in the aggregated list with a corresponding other item in the aggregated list into a corresponding dimension of the embedding vector thereby reducing a first dimensionality of the cooccurrence data to a second dimensionality of the embedding vector. The online system 140 clusters 425 (e.g., via the clustering module 250), using the plurality of embedding vectors for the items in the aggregated list, the aggregated list of items to a plurality of clusters of items, each of the plurality of clusters serviced by a different source.

The online system 140 may generate (e.g., via the clustering module 250) a respective distance of a plurality of distances between each pair of embedding vectors for each pair of items in the aggregated list. The online system 140 may cluster (e.g., via the clustering module 250), using the plurality of distances, a corresponding subset of items in the aggregated list having corresponding distances of the plurality of distances below a threshold distance into a corresponding cluster of the plurality of clusters. The online system 140 may recompute (e.g., via the clustering module 250), using embedding vectors of the corresponding subset of items, an embedding vector for the corresponding cluster. The online system 140 may recalculate (e.g., via the clustering module 250) a distance between the embedding vector for the corresponding cluster and at least one of an embedding vector for each item in the aggregated list that is not in the plurality of clusters. The online system 140 may repeat the clustering, the recomputing, and the recalculating (e.g., via the clustering module 250) until all items from the aggregated list are clustered into the plurality of clusters, wherein all items in each of the plurality of clusters are serviced by a different source.

The online system 140 may access a clustering machine-learning model of the online system 140 (e.g., via the clustering module 250), wherein the clustering machine-learning model is trained to predict a cluster of a plurality of clusters that each item from the aggregated list belongs to, each of the plurality of clusters serviced by a different source. The online system 140 may apply the clustering machine-learning model (e.g., via the clustering module 250) to the embedding vector of each item from the aggregated list to generate a plurality of scores for each item from the aggregated list, each score of the plurality of scores indicating a likelihood that each item from the aggregated list belongs to a respective cluster of the plurality of clusters.

The online system 140 may apply the clustering machine-learning model (e.g., via the clustering module 250) by comparing the embedding vector of each item from the aggregated list with embedding vectors of other items from the aggregated list to generate the plurality of scores for each item from the aggregated list. The online system 140 may assign (e.g., via the clustering module 250), using the plurality of embedding vectors of items from the aggregated list, an initial set of clusters to the aggregated list of items. The online system 140 may apply the clustering machine-learning model (e.g., via the clustering module 250) to the embedding vector of each item from the aggregated list to generate an initial set of scores for each item from the aggregated list, each score from the initial set of scores indicating a likelihood that each item from the aggregated list belongs to a respective cluster from the initial set of clusters. The online system 140 may compare (e.g., via the clustering module 250) each score from the initial set of scores to a threshold score. Responsive to identifying that each score from the initial set of scores is less than or equal to the threshold score, the online system 140 may extend (e.g., via the clustering module 250), using the plurality of embedding vectors of the items from the aggregated list, the initial set of clusters by one or more additional clusters to obtain the plurality of clusters assigned to the aggregated list, wherein at least one score from the plurality of scores for each item from the aggregated list is above the threshold score.

The online system 140 may retrieve (e.g., via the clustering module 250), from a database of the online system 140 (e.g., the data store) and using the identity of the user, the order data including information about a collection of orders placed by the user that were serviced by a collection of sources, each order from the collection of orders including a respective list of items having a respective list of embedding vectors. The online system 140 may apply (e.g., via the clustering module 250) the clustering machine-learning model further to the order data to generate the plurality of scores for each item from the aggregated list

The online system 140 may group (e.g., via the clustering module 250), using the plurality of scores for each item, each item from the aggregated list to a corresponding cluster of the plurality of clusters. The online system 140 may group (e.g., via the clustering module 250) each item from the aggregated list to the corresponding cluster so that a score of the plurality of scores that is associated with the corresponding cluster is the highest among all scores of the plurality of scores.

The online system 140 generates 430 (e.g., via the order management module 220), using order data for the user, a plurality of orders by including one or more items from each of the plurality of clusters to a respective order of the plurality of orders and assigning a different source of a plurality of sources to the respective order. The online system 140 generates 435 (e.g., via the content presentation module 210), using the plurality of orders, a user interface signal (e.g., user interface information). The online system 140 sends 440 (e.g., via the content presentation module 210), via a network (e.g., the network 130), the user interface signal to a device associated with the user (e.g., the user client device 100), wherein the sending causes the device associated with the user to display a user interface with information about the plurality of orders and the plurality of sources for servicing the plurality of orders. The online system 140 may send (e.g., via the content presentation module 210) the user interface signal to the device associated with the user, wherein the sending causes the device associated with the user to display the user interface further with a plurality of user interface elements, each of the plurality of user interface elements having a functionality to confirm servicing of a respective order of the plurality of orders or to modify servicing of the respective order.

The online system 140 may retrieve (e.g., via the order management module 220), from a database of the online system 140 (e.g., the data store 240) and using the identity of the user, the order data with information about a collection of orders placed by the user that were serviced by a collection of sources. The online system 140 may assign (e.g., via the order management module 220), using the order data, each cluster of the plurality of clusters to a corresponding source of the plurality of sources, the corresponding source being unique for each cluster of the plurality of clusters. The online system 140 may generate (e.g., via the content presentation module 210) the user interface signal including information about the corresponding source for servicing each order of the plurality of orders. The online system 140 may send (e.g., via the content presentation module 210) the user interface signal to the device associated with the user, wherein the sending causes the device associated with the user to display the user interface with the information about the corresponding source for servicing each order of the plurality of orders and a plurality of user interface elements, each user interface element of the plurality of user interface elements having a functionality to confirm servicing each order from the plurality of orders using the corresponding source, or to select a different source of the plurality of sources for servicing each order from the plurality of orders.

The online system 140 may retrieve (e.g., via the machine-learning training module 230), from a database of the online system 140 (e.g., the data store 240), training order data including information about to a set of orders placed by an example user of the online system within a threshold time period. The online system 140 may generate (e.g., via the machine-learning training module 230), using the training order data, labels for training data including information about a source used for servicing each order from the set of orders and information about cooccurrences of items in each order from the set of orders. Alternatively or additionally, the online system 140 may retrieve (e.g., via the machine-learning training module 230), from the database, training order data including information about a plurality of sets of orders, each set of orders from the plurality of sets of orders placed by a corresponding user of a plurality of users of the online system 140 within a threshold time period, the plurality of users located within a defined region and/or belonging to a defined type (e.g., cohort) of users. The online system 140 may then generate (e.g., via the machine-learning training module 230), using the training order data, labels for the training data, a set of labels of the plurality of labels related to each set of orders including information about a source used for servicing each order from each set of orders and information about cooccurrences of items in each order from each set of orders. The online system 140 may train (e.g., via the machine-learning training module 230), using the training data, the clustering machine-learning model to generate a set of initial values for a set of parameters of the clustering machine-learning model.

The online system 140 may receive (e.g., via the machine-learning training module 230), from the device associated with the user and via the network, feedback data including information about an engagement by the user with the plurality of orders. The engagement may be accepting servicing of the plurality of orders as displayed at the user interface (i.e., by accepting a recommended source for servicing each order) or modifying servicing of the plurality of orders by selecting some other source(s) or conversion channel(s) for servicing one or more orders of the plurality of orders. The online system 140 may re-train the clustering machine-learning model by updating (e.g., via the machine-learning training module 230), using the feedback data, the set of parameters of the clustering machine-learning model.

Embodiments of the present disclosure are directed to the online system 140 that performs clustering of items for multi-source servicing of an aggregated list of items. In one or more embodiments, the online system 140 utilizes a trained machine-learning model for multi-source servicing of the aggregated list of items. The machine-learning model is trained to shop the way that a user of the online system 140 would shop, in terms of which sources to choose and/or which conversion channel to choose for the aggregated list of items. In one or more other embodiments, the online system 140 applies the nearest neighbor algorithm to cluster items from the aggregated list of items into clusters of items, where each cluster of items can be serviced by a single source (or conversion channel) that is unique for that cluster.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, from an online platform and via an interface of an online system, a request signal including an aggregated list of items and an identity of a user of the online system associated with the aggregated list;
responsive to the received request signal, generating an order including the aggregated list of items;
identifying, based at least in part on a catalog of items of a single source, that the order is unserviceable by the single source;
responsive to identifying that the order is unserviceable, generating, for each of the items in the aggregated list, an embedding vector of a plurality of embedding vectors, wherein the embedding vector is generated by:
retrieving, from a database of the online system, information about past orders placed at the online system,
deriving, using the retrieved information, cooccurrence data for each of the items in the aggregated list including information about cooccurrences in the past orders of each of the items in the aggregated list with other items in the aggregated list, and
including, using the cooccurrence data, an indication about a cooccurrence of each of the items in the aggregated list with a corresponding other item in the aggregated list into a corresponding dimension of the embedding vector thereby reducing a first dimensionality of the cooccurrence data to a second dimensionality of the embedding vector;
clustering, using the plurality of embedding vectors for the items in the aggregated list, the aggregated list of items to a plurality of clusters of items, each of the plurality of clusters serviced by a different source;
generating, using order data for the user, a plurality of orders by including one or more items from each of the plurality of clusters to a respective order of the plurality of orders and assigning a different source of a plurality of sources to the respective order;
generating, using the plurality of orders, a user interface signal; and
sending, via a network, the user interface signal to a device associated with the user, wherein the sending causes the device associated with the user to display a user interface with information about the plurality of orders and the plurality of sources for servicing the plurality of orders.

2. The method of claim 1, wherein the clustering comprises:
generating a respective distance of a plurality of distances between each pair of embedding vectors for each pair of items in the aggregated list;
clustering, using the plurality of distances, a corresponding subset of items in the aggregated list having corresponding distances of the plurality of distances below a threshold distance into a corresponding cluster of the plurality of clusters;
recomputing, using embedding vectors of the corresponding subset of items, an embedding vector for the corresponding cluster;
recalculating a distance between the embedding vector for the corresponding cluster and at least one of an embedding vector for each item in the aggregated list that is not in the plurality of clusters; and
repeating the clustering, the recomputing, and the recalculating until all items from the aggregated list are clustered into the plurality of clusters, wherein all items in each of the plurality of clusters are serviced by a different source.

3. The method of claim 1, wherein the clustering comprises:
accessing a clustering machine-learning model of the online system, wherein the clustering machine-learning model is trained to predict a cluster of the plurality of clusters that each item from the aggregated list belongs to;
applying the clustering machine-learning model to the embedding vector of each item from the aggregated list to generate a plurality of scores for each item from the aggregated list, each score of the plurality of scores indicating a likelihood that each item from the aggregated list belongs to a respective cluster of the plurality of clusters; and
grouping, using the plurality of scores for each item, each item from the aggregated list to a corresponding cluster of the plurality of clusters.

4. The method of claim 3, further comprising:
retrieving, from the database, training order data including information about a set of orders placed by an example user of the online system within a threshold time period;
generating, using the training order data, labels for training data including information about a source used for servicing each order from the set of orders and information about cooccurrences of items in each order from the set of orders; and
training, using the training data, the clustering machine-learning model to generate a set of initial values for a set of parameters of the clustering machine-learning model.

5. The method of claim 3, further comprising:
retrieving, from the database, training order data including information about a plurality of sets of orders, each set of orders from the plurality of sets of orders placed by a corresponding user of a plurality of users of the online system within a threshold time period, the plurality of users located within a defined region;
generating, using the training order data, a plurality of labels for training data, a set of labels of the plurality of labels related to each set of orders including information about a source used for servicing each order from each set of orders and information about cooccurrences of items in each order from each set of orders; and
training, using the training data, the clustering machine-learning model to generate a set of initial values for a set of parameters of the clustering machine-learning model.

6. The method of claim 3, further comprising:
retrieving, from the database, training order data including information about a plurality of sets of orders, each set of orders from the plurality of sets of orders placed by a corresponding user of a plurality of users of the online system within a threshold time period, the plurality of users belonging to a defined type of users;
generating, using the training order data, a plurality of labels for training data, a set of labels of the plurality of labels related to each set of orders including information about a source used for servicing each order from each set of orders and information about cooccurrences of items in each order from each set of orders; and
training, using the training data, the clustering machine-learning model to generate a set of initial values for a set of parameters of the clustering machine-learning model.

7. The method of claim 3, wherein applying the clustering machine-learning model comprises:
assigning, using the plurality of embedding vectors for items from the aggregated list, an initial set of clusters to the aggregated list of items;
applying the clustering machine-learning model to the embedding vector of each item from the aggregated list to generate an initial set of scores for each item from the aggregated list, each score from the initial set of scores indicating a likelihood that each item from the aggregated list belongs to a respective cluster from the initial set of clusters;
comparing each score from the initial set of scores to a threshold score; and
responsive to identifying that each score from the initial set of scores is less than or equal to the threshold score, extending, using the plurality of embedding vectors, the initial set of clusters by one or more additional clusters to obtain the plurality of clusters assigned to the aggregated list, wherein at least one score from the plurality of scores for each item from the aggregated list is above the threshold score.

8. The method of claim 3, wherein applying the clustering machine-learning model comprises:
comparing the embedding vector of each item from the aggregated list with embedding vectors of other items from the aggregated list to generate the plurality of scores for each item from the aggregated list.

9. The method of claim 3, wherein applying the clustering machine-learning model comprises:
retrieving, from the database and using the identity of the user, the order data including information about a collection of orders placed by the user that were serviced by a collection of sources, each order from the collection of orders including a respective list of items having a respective list of embedding vectors; and
applying the clustering machine-learning model further to the order data to generate the plurality of scores for each item from the aggregated list.

10. The method of claim 3, wherein grouping each item from the aggregated list to the corresponding cluster comprises:
grouping each item from the aggregated list to the corresponding cluster so that a score of the plurality of scores that is associated with the corresponding cluster is the highest among all scores of the plurality of scores.

11. The method of claim 3, further comprising:
receiving, from the device associated with the user and via the network, feedback data including information about an engagement by the user with the plurality of orders; and
re-training the clustering machine-learning model by updating, using the feedback data, a set of parameters of the clustering machine-learning model.

12. The method of claim 1, wherein sending the user interface signal comprises:
sending the user interface signal to the device associated with the user, wherein the sending causes the device associated with the user to display the user interface further with a plurality of user interface elements, each of the plurality of user interface elements having a functionality to confirm servicing of a respective order of the plurality of orders or to modify servicing of the respective order.

13. The method of claim 1, wherein generating the plurality of orders comprises:
retrieving, from the database and using the identity of the user, the order data with information about a collection of orders placed by the user that were serviced by a collection of sources; and
assigning, using the order data, each cluster of the plurality of clusters to a corresponding source of the plurality of sources, the corresponding source being unique for each cluster of the plurality of clusters.

14. The method of claim 1, wherein:
generating the user interface signal comprises generating the user interface signal including information about the corresponding source for servicing each order of the plurality of orders; and
sending the user interface signal comprises sending the user interface signal to the device associated with the user, wherein the sending causes the device associated with the user to display the user interface with the information about the corresponding source for servicing each order of the plurality of orders and a plurality of user interface elements, each user interface element of the plurality of user interface elements having a functionality to confirm servicing each order from the plurality of orders using the corresponding source, or to select a different source of the plurality of sources for servicing each order from the plurality of orders.

15. A computer program product comprising a non-transitory computer readable storage medium having instructions encoded thereon that, when executed by a processor, cause the processor to perform steps comprising:
receiving, from an online platform and via an interface of an online system, a request signal including an aggregated list of items and an identity of a user of the online system associated with the aggregated list;
responsive to the received request signal, generating an order including the aggregated list of items;
identifying, based at least in part on a catalog of items of a single source, that the order is unserviceable by the single source;
responsive to identifying that the order is unserviceable, generating, for each of the items in the aggregated list, an embedding vector of a plurality of embedding vectors, wherein the embedding vector is generated by:
retrieving, from a database of the online system, information about past orders placed at the online system,
deriving, using the retrieved information, cooccurrence data for each of the items in the aggregated list including information about cooccurrences in the past orders of each of the items in the aggregated list with other items in the aggregated list, and
including, using the cooccurrence data, an indication about a cooccurrence of each of the items in the aggregated list with a corresponding other item in the aggregated list into a corresponding dimension of the embedding vector thereby reducing a first dimensionality of the cooccurrence data to a second dimensionality of the embedding vector;
clustering, using the plurality of embedding vectors for the items in the aggregated list, the aggregated list of items to a plurality of clusters of items, each of the plurality of clusters serviced by a different source;
generating, using order data for the user, a plurality of orders by including one or more items from each of the plurality of clusters to a respective order of the plurality of orders and assigning a different source of a plurality of sources to the respective order;
generating, using the plurality of orders, a user interface signal; and
sending, via a network, the user interface signal to a device associated with the user, wherein the sending causes the device associated with the user to display a user interface with information about the plurality of orders and the plurality of sources for servicing the plurality of orders.

16. The computer program product of claim 15, wherein the instructions further cause the processor to perform steps comprising:
generating a respective distance of a plurality of distances between each pair of embedding vectors for each pair of items in the aggregated list;
clustering, using the plurality of distances, a corresponding subset of items in the aggregated list having corresponding distances of the plurality of distances below a threshold distance into a corresponding cluster of the plurality of clusters;
recomputing, using embedding vectors of the corresponding subset of items, an embedding vector for the corresponding cluster;
recalculating a distance between the embedding vector for the corresponding cluster and at least one of an embedding vector for each item in the aggregated list that is not in the plurality of clusters; and
repeating the clustering, the recomputing, and the recalculating until all items from the aggregated list are clustered into the plurality of clusters, wherein all items in each of the plurality of clusters are serviced by a different source.

17. The computer program product of claim 15, wherein the instructions further cause the processor to perform steps comprising:
accessing a clustering machine-learning model of the online system, wherein the clustering machine-learning model is trained to predict a cluster of the plurality of clusters that each item from the aggregated list belongs to;
applying the clustering machine-learning model to the embedding vector of each item from the aggregated list to generate a plurality of scores for each item from the aggregated list, each score of the plurality of scores indicating a likelihood that each item from the aggregated list belongs to a respective cluster of the plurality of clusters; and
grouping, using the plurality of scores for each item, each item from the aggregated list to a corresponding cluster of the plurality of clusters.

18. The computer program product of claim 17, wherein the instructions further cause the processor to perform steps comprising:
retrieving, from the database, training order data including information about a set of orders placed by an example user of the online system within a threshold time period;
generating, using the training order data, labels for training data including information about a source used for servicing each order from the set of orders and information about cooccurrences of items in each order from the set of orders;
training, using the training data, the clustering machine-learning model to generate a set of initial values for a set of parameters of the clustering machine-learning model;
receiving, from the device associated with the user and via the network, feedback data including information about an engagement by the user with the plurality of orders; and
re-training the clustering machine-learning model by updating, using the feedback data, the set of parameters of the clustering machine-learning model.

19. The computer program product of claim 15, wherein the instructions further cause the processor to perform steps comprising:
generating the user interface signal including information about the corresponding source for servicing each order of the plurality of orders; and
sending the user interface signal to the device associated with the user, wherein the sending causes the device associated with the user to display the user interface with the information about the corresponding source for servicing each order of the plurality of orders and a plurality of user interface elements, each user interface element of the plurality of user interface elements having a functionality to confirm servicing each order from the plurality of orders using the corresponding source, or to select a different source of the plurality of sources for servicing each order from the plurality of orders.

20. A computer system comprising:
a processor; and
a non-transitory computer-readable storage medium having instructions that, when executed by the processor, cause the computer system to perform steps comprising:
receiving, from an online platform and via an interface of an online system, a request signal including an aggregated list of items and an identity of a user of the online system associated with the aggregated list;
responsive to the received request signal, generating an order including the aggregated list of items;
identifying, based at least in part on a catalog of items of a single source, that the order is unserviceable by the single source;
responsive to identifying that the order is unserviceable, generating, for each of the items in the aggregated list, an embedding vector of a plurality of embedding vectors, wherein the embedding vector is generated by:
retrieving, from a database of the online system, information about past orders placed at the online system,
deriving, using the retrieved information, cooccurrence data for each of the items in the aggregated list including information about cooccurrences in the past orders of each of the items in the aggregated list with other items in the aggregated list, and
including, using the cooccurrence data, an indication about a cooccurrence of each of the items in the aggregated list with a corresponding other item in the aggregated list into a corresponding dimension of the embedding vector thereby reducing a first dimensionality of the cooccurrence data to a second dimensionality of the embedding vector;
clustering, using the plurality of embedding vectors for the items in the aggregated list, the aggregated list of items to a plurality of clusters of items, each of the plurality of clusters serviced by a different source;
generating, using order data for the user, a plurality of orders by including one or more items from each of the plurality of clusters to a respective order of the plurality of orders and assigning a different source of a plurality of sources to the respective order;
generating, using the plurality of orders, a user interface signal; and
sending, via a network, the user interface signal to a device associated with the user, wherein the sending causes the device associated with the user to display a user interface with information about the plurality of orders and the plurality of sources for servicing the plurality of orders.
